(19) United States
(12) Patent Application Publication
(10) Pub. No.: US 2002/0148293 A1
(43) Pub. Date: Oct. 17, 2002

(54) Method and apparatus for the measurement of corrosion and damage in installed bolts, rods and bars

(76) Inventors: Timothy Little, Beaverbank (CA); James P. Spivey, Truro (CA)

Correspondence Address: John A. Baker, Kirby Eades Gale Baker, Box 3432, Station D, Ottawa, ON, K1P 6N9, CA

(21) Appl. No.: 10/120,522

(22) Filed: Apr. 12, 2002

Related U.S. Application Data
(60) Provisional application No. 60/283,343, filed on Apr. 13, 2001.

(51) Int. Cl. G01N 29/04

(52) U.S. Cl. 73/579

(57) ABSTRACT

An apparatus and method are described for measuring the structural integrity of a rod of constant cross-section without visual or other physical access to the full length of the rod. The present invention is useful for measuring the degree of rust and corrosion of such rods, as well as change in their chemical and structural composition and physical damage such as fractures or cracks. The invention is particularly useful when applied to rods or bolts such as those installed in telephone poles, bridges, concrete buildings, and other structures where there is no access to the middle or center portion of the rod. The present invention uses transmitted and/or reflected acoustic energy to determine the structural integrity of the rod under test.

### RELATED APPLICATION

This application is related to U.S. provisional patent application Serial No. 60/283,343, which was filed on Apr. 13, 2001.

### BACKGROUND OF THE INVENTION

1. Field of the Invention

The field of the invention is the detection of structural irregularities in rods; specifically, the measurement and assessment of the presence of rust, corrosion, physical damage, or any change in chemical or structural composition in metallic rods, bolts, bars, beams, girders and other constant cross-section structures.

2. Description of the Prior Art

Power and telephone companies commonly use wooden or concrete poles, of six to eighteen inches in diameter, to raise their distribution wires above ground level. Metal bolts or rods of an approximate 12 to 24 inches in length, usually of constant cross-section, are driven through the poles to support and mount cross-stays, support wires, distribution equipment, isolation hangers and the like. Although the ends of the rods protrude through the wood or concrete poles, the central areas of the rods are inaccessible once installed, being “hidden” inside the pole.

Although these rods are normally galvanized to prevent rust, and although the wooden poles are preserved through a variety of chemical processes, it has recently become apparent that these measures do not prevent corrosion from occurring in the “hidden” area of the rod. This corrosion can be the result of trapped water, the effects of pole preservation chemicals, or from the electrical field effects of the attached equipment. This corrosion causes the central cross-sectional area of the rod to be reduced, thereby reducing the maximum longitudinal load the rod can support. Since the rods commonly carry considerable load, such as heavy peripheral equipment, distribution wire loads and pole stay wire loads, the sudden physical failure of the rod poses a physical threat to passersby and linemen. As a result, the regular and accurate assessment of these rods for the presence of corrosion is an imperative matter of public safety.

A common method of assessing the level of corrosion of these rods is the visual inspection of the entire rod length. As this method requires the complete physical removal of the rod from the pole, it is a difficult, expensive, and time-consuming process. It involves either the prior installation of alternate support for the attached equipment, or the removal from service, and from the pole, of such equipment to provide for the removal of the rod to be assessed. Further, visual inspection does not allow for the identification of non-obvious physical damage such as small cracks. The determination of the presence of small cracks is essential to any such reliable assessment technique, as small cracks can have a significant effect on the strength of a rod, since the maximum load-carrying ability of a given rod is directly related to its cross-sectional area.

There are also limitations among non-visual methods of assessment. Due to the great size, mass, and power requirements of the equipment used in some methods, the rod must still be fully removed from the pole. Methods allowing for the in situ measurement of the rod can involve a requirement to process film or recorded intermediate results on separate output equipment or at specialized results processing laboratories, creating a slow and complicated process. Methods utilizing eddy current production, x-ray imaging, electrical transmission, and magnetic anomaly detection require the removal of metallic and electrical equipment attached to the rod being assessed in order to obtain accurate, reliable readings. This need to remove peripheral equipment prior to assessment increases the complexity, time and cost of these assessment methods.

There are prior art patents that teach various methods for attempting to determine the structural integrity of metallic elements.

U.S. Pat. No. 6,015,484, which issued on Jan. 18, 2000 covers the use of similar-metal “samples” used to monitor and detect the onset or degree of corrosion present in a metal wall, pipe or container. This patent uses voltage-bias on the samples to amplify or encourage the electrical difference arising between the samples (electrodes) due to corrosive action. This and similar patents use a totally different method of detecting corrosion than the acoustic wave method and apparatus of the present invention. They detect the electrical noise arising from the corrosive action itself. In addition, the corrosion detected in this patent is of a different type and order than the corrosion sought to be detected by the present invention. This patent detects the wear in the metal wall of liquid containers that arises due to chemical action, high temperature and/or pressure. Typically this “wear” is pitting, microcracking and localized deterioration of the metal surface. The present invention measures the large scale corrosion such as rust, metal removal, flaking, etc.

U.S. Pat. No. 5,526,689 which issued on Jun. 18, 1996 uses broad band acoustic noise generated by the incidence of high pressure compressed air onto the outside surface of a test subject pipe which is covered by insulation. The resulting acoustic signals contain frequencies in the range of 0 to 1 MHz. The method of operation is that the surface waves injected are “damped” by the presence of paint, oxide scale or even by the adherence of insulation to the pipe in the presence of corrosion, i.e., energy is absorbed as it passes along the outside surface of the pipe under test. As a result, detecting the signals further along the pipe and comparing the RMS signal amplitude detected with that expected, provides an indicator of the presence of corrosion on the outside surface of the pipe under test. On the other hand, the present invention tests solid objects such as bolts, rods and bars rather than hollow pipes. The present invention uses a single frequency signal rather than a broad band noise signal which travels on both the surface and within the rod under test.

U.S. Pat. No. 4,603,584 which issued on Aug. 5, 1986 covers the use of permanently mounted acoustic transducers to periodically monitor large-scale, potentially irregular shaped metal structures, such as oil rigs, bridges, and pressure vessels. Trains of acoustic pulses are injected via one transducer and received at one or more of the other transducers. The received wavetrain is digitized, processed and stored, then compared to previously stored versions of the received wavetrain. Any differences are taken to be due to the development of structural damage, flaws, cracks or broken welds since the previous periodic monitoring. In the present invention, in one embodiment continuous acoustic waves are both generated and detected until a reading is obtained. In another embodiment of the present invention, where the transmission and reception is carried out at the same end of the bolt under test, a short duration pulse of acoustic energy is used and then the received acoustic energy is detected and produces an analog indication of the structural integrity of the bolt.

### SUMMARY OF THE INVENTION

The present invention provides an apparatus and method for measuring the structural integrity of a rod of constant cross-section without visual or other physical access to the full length of the rod. The present invention is useful for measuring the degree of rust, corrosion, physical damage such as fractures or cracks, and for measuring change in their chemical and structural composition. The present invention is particularly useful when applied to rods or bolts such as those installed in telephone poles, bridges, concrete buildings, and other structures where there is no access to the middle or center portion of the rod.

An embodiment of the present invention uses acoustic energy, (a combination of surface waves and longitudinal waves), which is directed into the rod at a first end. The acoustic energy is generated by an electrical-to-mechanical transducer, where the electrical input signal is of known peak-to-peak amplitude and known frequency. The frequency used depends upon the characteristics (weight, size, length etc.) of the rod to be assessed. When applied to telephone pole rods, frequencies in the range of 100 to 600 kHz are effective, and the vicinity of 300 kHz provides the optimum energy transfer. A mechanical-to-electrical transducer is fitted at a second end of the rod to detect and measure the peak-to-peak amplitude of the acoustic surface wave signal transmitted down the rod.

The acoustic energy transmitted from the first end of the rod to the second end of the rod is dependent upon the continuity and regularity of the rod. Any disturbance in the surface or internal structure of the rod causes a loss of signal over and above the normal signal loss. Given the expected signal amplitude at the second end of the rod for a “normal”, structurally sound rod, a comparison between this value and that received from a given rod-under-test constitutes a direct assessment of the surface continuity and structural continuity of the rod-under-test. There is a predictable, linear relationship between amplitude of the received signal and the degree of corrosion of a rod.

The amplitude of the received signal (for a given rod signal) depends upon the characteristics of both the rod itself and of the material the rod is embedded within. The present invention can be calibrated to correctly assess particular rods under particular circumstances (e.g. 0.5 inch diameter rods of lengths 14 inches to 18 inches in a wooden pole). A single embodiment of the invention can be used in a wide variety of applications, rod sizes, rod lengths, and installation media by incorporating the appropriate adjustment mechanism (such as a manual switch) in its design.

The present invention is not limited to use with rods of constant cross-section. Any deviation from the expected amplitude for a given rod under test (whether an increase or decrease in amplitude), indicates a deviation of some kind from the expected surface condition, and allows the inference of the presence of corrosion, physical damage, incorrect installation or faulty manufacture.

An important characteristic of an embodiment is extreme portability and ease-of-use in difficult, extreme conditions. Rods are often installed 18 feet or more above ground level and often within 2 or 3 feet of high voltage power lines. Linemen work outside, often in rain, cold or other difficult circumstances. Light weight, portability and ease of use are therefore very important features of the current device. A particular embodiment of the present invention is relatively small and light in weight and is battery operated. This adds portability and increases safety in areas where the use of mains-level power could be dangerous.

Another important characteristic of an embodiment is the provision for instant assessment of the rod condition, thus allowing a lineman to take immediate action should an adverse reading be obtained. There is no requirement for further processing of intermediate results in order to obtain final corrosion assessment. Using this embodiment, a lineman may replace a corroded rod immediately without descending from the pole or structure.

Other desirable characteristics of a preferred embodiment are low production costs, minimal training requirements, and the provision of an insulated, shielded, hand-size container to avoid the generation of electrical fields that would interfere with the telephone signals present on the distribution wires.

In accordance with one aspect of the present invention, an apparatus is provided for use in measuring the structural integrity of a rod having a first end and a second end. This apparatus comprises means for generating acoustic wave energy at the first end of the rod, and means for measuring the amplitude of acoustic wave energy received at either the second end of the rod or at the first end of the rod reflected back from the second end of the rod. The apparatus also provides means for displaying the amplitude, wherein the amplitude is an indication of the structural integrity of the rod.

In accordance with another aspect of the present invention, a method is provided for use in measuring the structural integrity of a rod having a first end and a second end. This method comprises the steps of generating acoustic wave energy at said first end of the rod and measuring the amplitude of acoustic wave energy received at the second end of the rod or at the first end of the rod reflected back from the second end of the rod. The method also includes the step of displaying the amplitude, wherein the amplitude is an indication of the structural integrity of the rod.

In accordance with yet another aspect of the present invention there is provided a transducer interface housing. This transducer interface housing comprises a first metallic block half located adjacent to a second metallic block half, an aperture formed in the first and second block halves for connection to the rod under test, a spring-loaded fastener for connecting the first block and second block halves together and for urging the first and second block halves into acoustic contact with the rod under test. The apparatus also includes means for attaching the transducer.

### BRIEF DESCRIPTION OF THE DRAWINGS

An embodiment of the present invention is described hereinbelow with the aid of the accompanying drawings, in which:

FIG. 1 shows an embodiment of the present invention in use with a typical corroded rod in situ;

FIG. 2 shows a typical portable corrosion assessment device according to the present invention;

FIG. 3 is a graph of signal amplitude versus rod condition;

FIG. 4 is a schematic diagram of one embodiment of an electronic circuit of a device according to the present invention;

FIG. 5 is a schematic diagram of another embodiment of an electronic circuit of a device according to the present invention;

FIGS. 6A and 6B show a transducer interface housing.

### DETAILED DESCRIPTION OF THE DRAWINGS

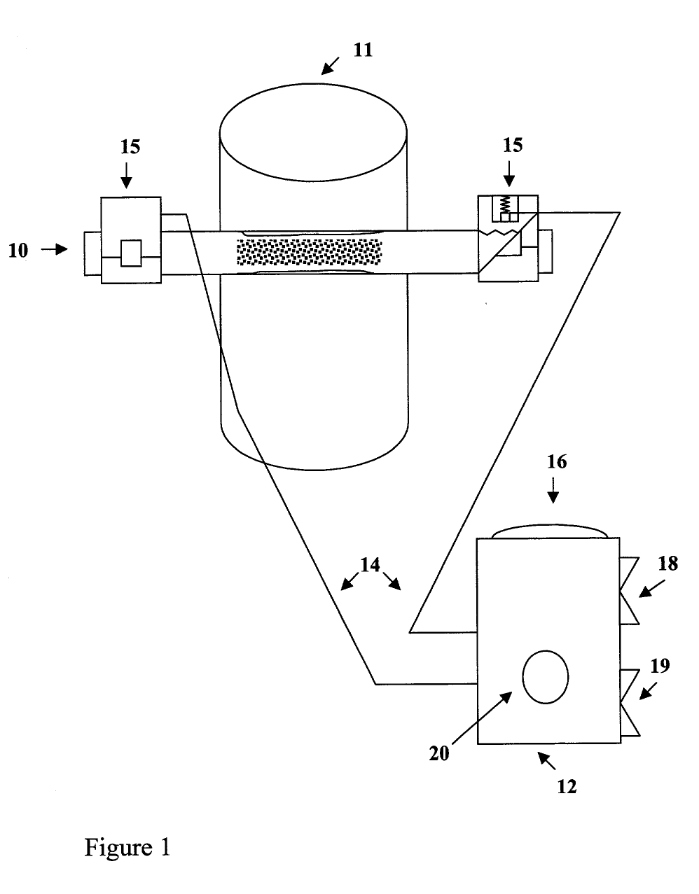

FIG. 1 shows a typical peripheral-mounting rod 10 installed in telephone pole 11 with an assessment device 12 of the present invention connected thereto. The ends of the rod protrude from telephone pole 11. Not shown is a cross-stay, peripheral equipment or cable supporting mechanism that would optionally be mounted on telephone pole 11 by the rod. The centre portion of the rod within telephone pole 11 is corroded. Assessment device 12 is connected by electrical leads 14 to electrical/mechanical transducers 15 connected at each end of the rod. The transducer at one end of the rod transmits the acoustic signal, while the transducer at the other end of the rod receives the signal. A measurement is taken by assessment device 12 and is displayed through incorporated panel meter 16, which acts as a display unit. For example, panel meter 16 may display a value from 0 to 10, wherein a reading below 5 indicates that the rod should be replaced. Switch 18 of assessment device 12 is an on/off battery switch. Switch 19 is a range adjusting switch to allow the use of assessment device 12 with differing rod dimensions. Alternatively, switch 19 can be used to activate a battery test capability. Rotary control knob 20 allows the limited adjustment of the frequency of the acoustic signal such as to maximize the amplitude of the received signal. Another embodiment of the display unit might involve qualitative readings such as “high” corrosion and “low” corrosion.

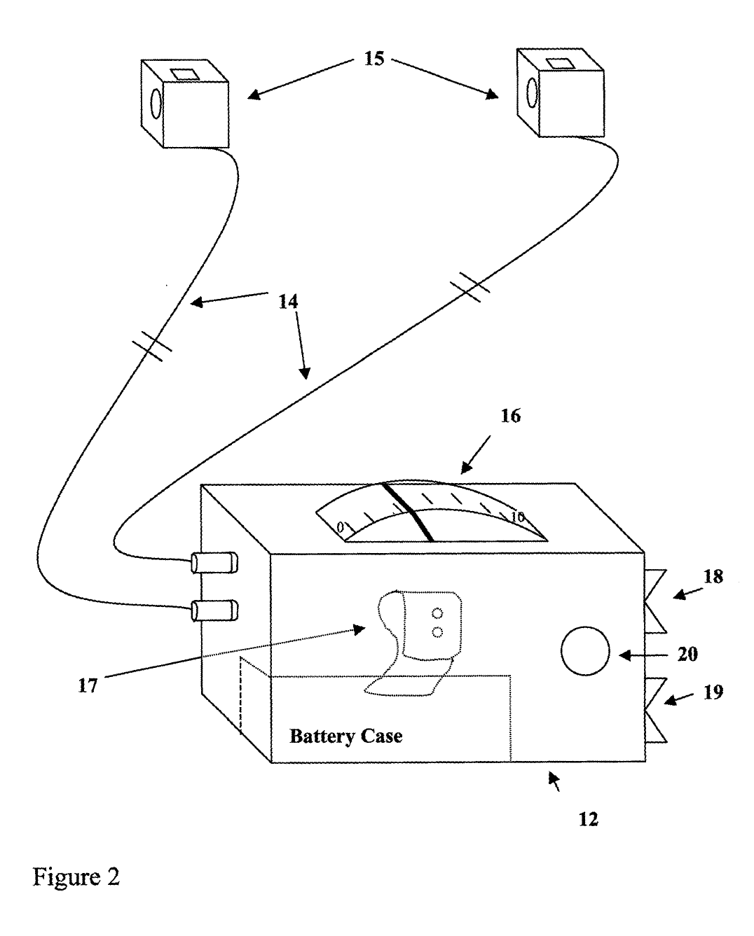

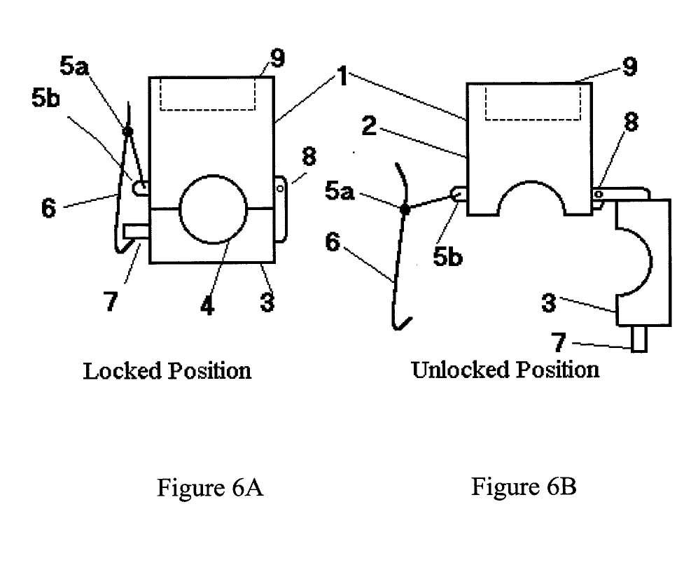

FIG. 2 shows assessment device 12 and its connecting transducers 15 in more detail. Assessment device 12 is a small box (approximately 6″×6″×1″) containing two 9-Volt batteries and some electronics (not shown). Assessment device 12 may include belt clip 17 or the like, mounted on the back of the unit. Electrical/mechanical transducers 15 are mounted to connectors that snap on to the rod ends through the use of a spring-loaded clip, which is more fully described with respect to FIG. 6. Sufficient stiffness of the clip ensures a tight connection between the connector carrying the transducer and the rod which ensures proper transfer of acoustic energy. Switches 18 and 19 and control 20 are those described in FIG. 1.

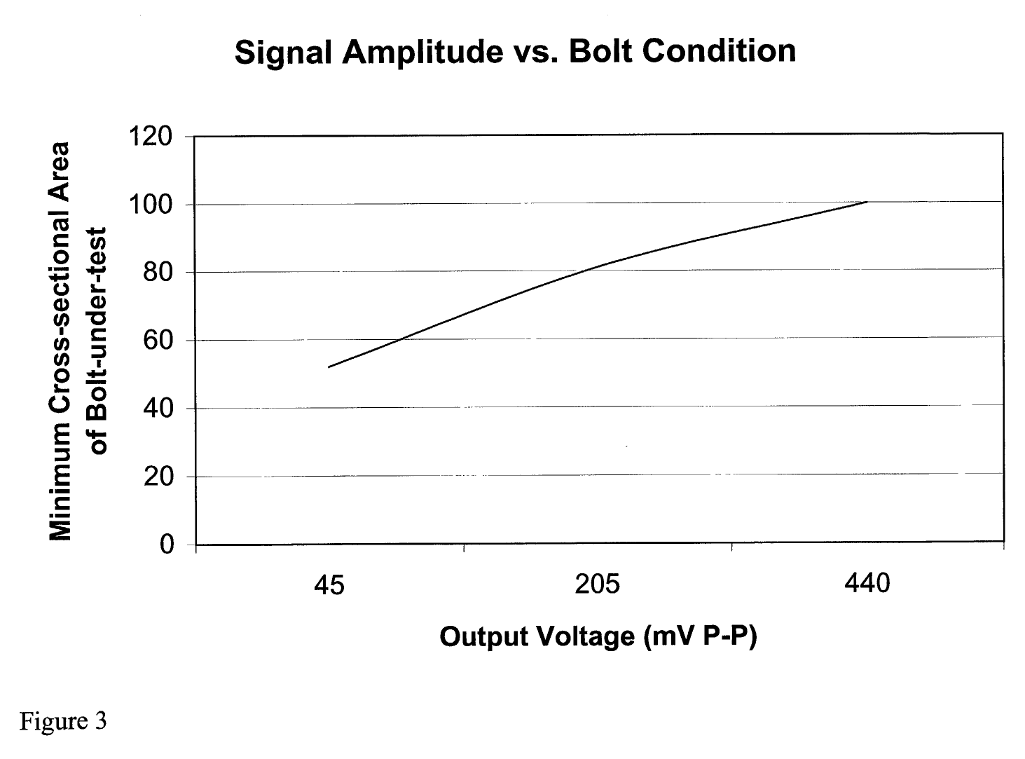

FIG. 3 shows the relationship between the received signal amplitude and rod corrosion. It can be seen that as the corroded area of a rod increases, the received signal amplitude decreases in a nearly linear relationship. This relationship allows the magnitude of the received signal to be used to drive the display unit. The appropriate signal amplitude thresholds can be selected either empirically or based on this type of graph, and will likely vary for each application and for each type of bolt, beam, rod or bar to be tested.

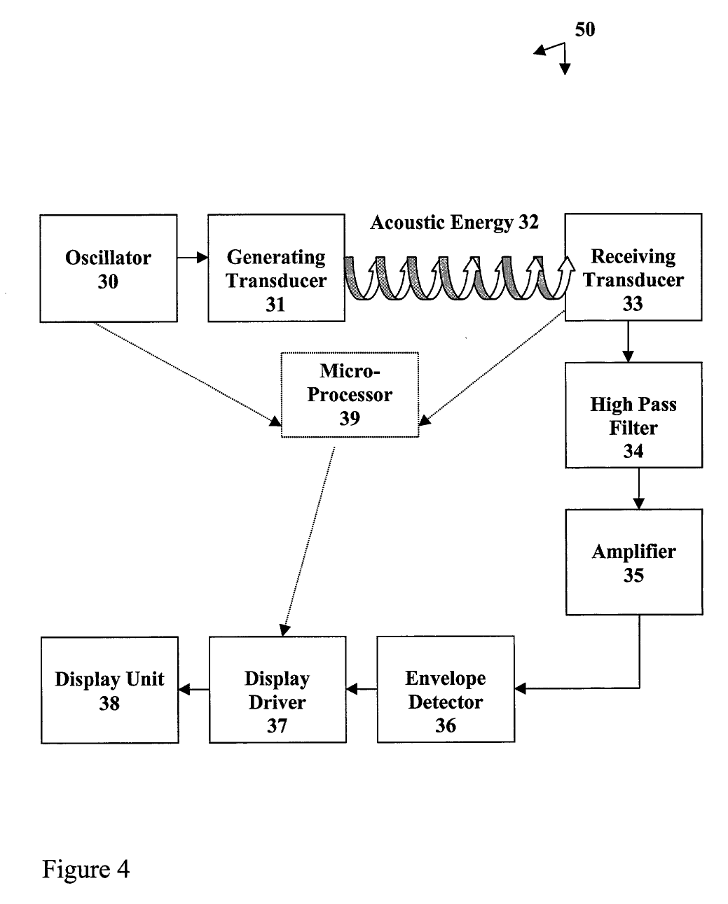

FIG. 4 is a general schematic diagram of the electronic system 50 of an embodiment of the present invention. Oscillator 30 is used to generate a sinusoidal signal of 15 Volts peak-to-peak in the frequency range of 100 kHz to 600 kHz, dependant on the application of the device, optimally in the 220 kHz to 260 kHz range for telephone and power pole mounted bolts. The signal is passed to electrical-to-mechanical transducer 31 connected to one end of the rod to be tested. Acoustic energy 32 passes down the rod, where it is attenuated by normal losses and by corrosion if present, and is received by mechanical-to-electrical transducer 33 at the other end of the rod. The received signal is then passed through active, second-order, high pass filter 34 set at 100 kHz in order to reject any possible trace of 60 Hz mains interference and any harmonics accumulated from the line equipment attached to the pole or in close proximity to the tester. The filtered signal is passed to amplifier 35 followed by envelope detector 36. Envelope detector 36 effectively turns the received sinusoidal signal into a DC signal of voltage proportional to the amplitude of the received sinusoidal signal. The DC signal is then passed to display driver circuitry 37, the output of which is proportional to the level of the DC signal. The correlation between the received DC voltage and the appropriate display values is programmable through internal adjustment to the display driver circuitry, based on the specific properties of the rod under test. For example, switch 19 can adjust attenuator resistors in display driver 37 to compensate the voltage sent to display unit 38 dependent on rod diameter.

In one embodiment where the assessment device is designed for one rod diameter only, the only adjustment necessary by the user is that of the frequency generated by oscillator 30, which is manually adjusted by control 20 for each rod to maximize the received signal. This adjustment effectively tunes the frequency such that a maxima node coincides with the position of receiving transducer 33. This is necessary in order to provide comparable results between rods of differing length and in a case where the acoustic transducers are spaced differently on the rod under test. The user therefore merely turns the adjustment until the maximum reading is obtained, and this reading will indicate the degree of wear, such as corrosion, crack, or fracture, of that rod. Another embodiment automates this manual adjustment of frequency by electronically sweeping the frequency range and using a latching circuit to halt the sweep at the frequency resulting in the maximum received signal.

An alternate embodiment of the present invention incorporates microprocessor 39 into system 50 to provide the ability to discriminate between different types of defects (such as corrosion or cracks). Microprocessor 39 allows enhanced corrosion detection and improved decision making to be applied to the device in order to give the user more and better information about the state of the rod-under-test. Appropriate numerical algorithms for enhanced corrosion detection include numerical integration, pulse detection, Fourier transforms, and spectral and noise analysis. Improved decision making involves multiple node analysis, fuzzy logic and neural network methods.

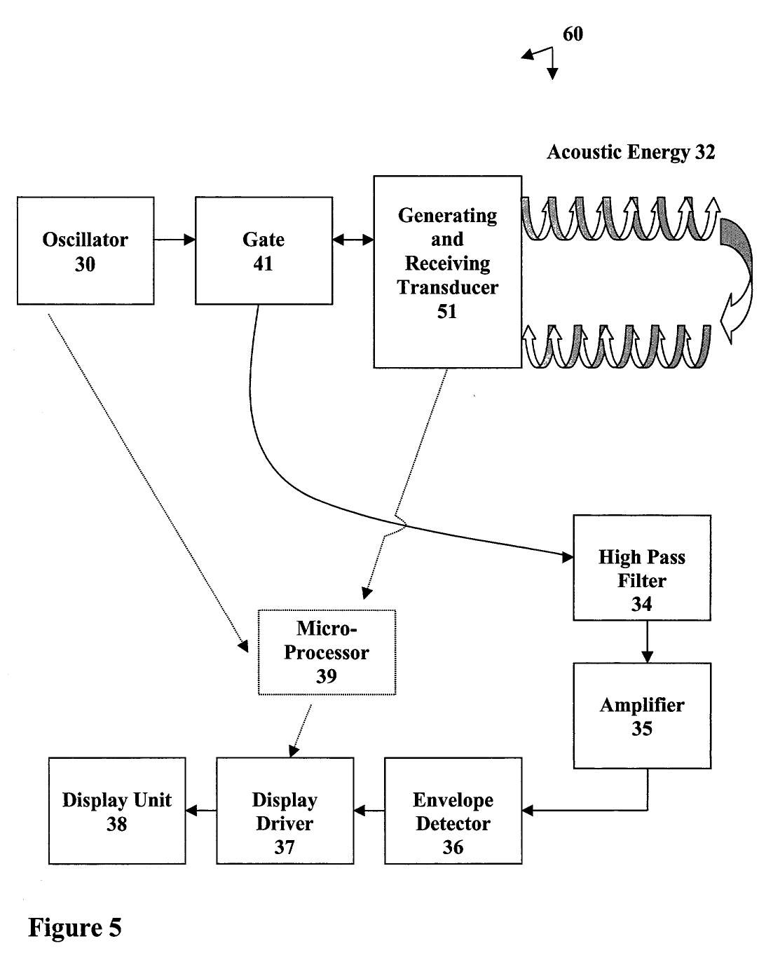

A further embodiment of the present invention provides for both the generation and receipt of acoustic energy at the first end of the rod, as shown by FIG. 5. In this case, acoustic energy 32 will be reflected from the second end of the rod such that it is possible for both transmitter and receiver to be at the first end. A single electrical/mechanical transducer 50 with connection to the rod at only one point may perform both transmitting and receiving functions. The strength of the received signal in this embodiment is lower than that of the embodiment of FIG. 4 and therefore requires greater amplification, which can be performed by amplifier 35. The lowered signal strength is due to the two necessary traversals of the rod and its corrosion. Since the signal is propagating through the rod at the speed of sound and the electronics process the signal very much faster, the signal path can be switched through gate 41 to allow it to sent and received through the same transducer.

FIGS. 6A and 6B show an embodiment of a transducer interface housing used in conjunction with the present invention. The housing 1 is comprised of two halves 2 and 3, which, when in the closed position provide an aperture 4 which is closely dimensioned, even threaded, to fit over the end of a bolt under test. The two halves are joined at one side by a hinge 8. Hinges 5a and 5b, spring 6 and locking pin 7 form an assembly which connects the two halves 2 and 3 together over the end of the bolt to be tested. A recess 9 is provided in the housing half 2 for insertion of an acoustic transducer, not shown. The recess provides protection for the transducer. The housing provides a good acoustic interface between the transducer and the bolt under test.

This arrangement is particularly useful in carrying out testing of a bolt in situ because it can be manipulated by a lineman using only one hand.

In use, the lineman insures that the interface 1 is in the open configuration. The lineman then places the housing half 3 along the bottom of the end of the bolt under test and presses the other housing half 2 onto the bolt end. The hinge 8 allows the housing half 2 to pivot with respect to the housing half 3 so that both engage the bolt end. Hinges 5a and 5b allow the spring 6 to be pressed onto the housing so that the end of spring 6 engages locking pin 7, thereby securing the transducer interface housing 1 to the bolt under test. Urging the spring 6 outwardly, away from housing 1 will disengage the spring 6 from the locking pin 7 so that the housing can be removed from the bolt under test.

An example of a suitable transducer for use with embodiments of the present invention is a Physical Acoustics Model Number μ30.

The device has been described in terms of its application to rods or bolts, and in particular to metallic rods used on power or telephone poles for the installation of cross-bars, insulator supports, peripheral equipment and pole stays. However, the present invention is not limited to such rods and bolts, but is applicable to a broad range of constant cross-sectional structures. Examples include girders used to support civil engineering structures such as bridges, platforms, piers, wharves and buildings where access to one or both ends of the structures is possible but the center of the girder is embedded within the civil engineering structure. Further examples include rack bolts used to stabilize tunnel and mine walls, pre-stressing tendons in civil engineering structures, and non-metallic rods such as composite bars used in the above applications where such composite bars will conduct acoustic energy.

1. An apparatus for use in measuring the structural integrity of a rod having a first end and a second end, said apparatus comprising:
means for generating acoustic wave energy at said first end of said rod;
means for measuring the amplitude of acoustic wave energy received at said second end of said rod; and
means for displaying said amplitude;
wherein said amplitude is an indication of said structural integrity of said rod.

2. The apparatus of claim 1, wherein said apparatus further comprises:
means for comparing said amplitude with a standard amplitude derived from a similar rod having a known structural integrity.

3. An apparatus for comparing the structural integrity of a rod under test to a similar rod of known structural integrity, said rod under test having a first end and a second end, said apparatus comprising:
means for generating acoustic wave energy at said first end of said rod under test;
means for measuring said amplitude of acoustic wave energy received at said second end of said rod under test;
means for calculating a ratio between said amplitude of said received acoustic wave energy and a predetermined value representing said structural integrity of said similar rod; and
means for displaying said ratio.

4. The apparatus of claim 1, further comprising means for adjusting the frequency of said generated acoustic wave energy to maximize said amplitude of said received acoustic wave energy.

5. The apparatus of claim 1 wherein the frequency of said acoustic wave energy is in said range from 100 kHz to 600 kHz.

6. The apparatus of claim 1, wherein said apparatus further includes an acoustic transducer located in a transducer interface housing.

7. The apparatus of claim 6, wherein said transducer interface housing comprises:
a first metallic block half located adjacent to a second metallic block half;
an aperture formed in said first block half and second block half for connection to said rod under test;
a spring-loaded clip fastener for connecting said first block half and said second block half together and for urging said first and second block halves into acoustic contact with said rod under test; and
means for attaching said transducer.

8. An apparatus for use in measuring the structural integrity of a rod having a first end and a second end, said apparatus comprising:
means for generating acoustic wave energy at said first end of said rod;
means for measuring the amplitude of acoustic wave energy received at said first end of said rod reflected back from said second end of said rod; and
means for displaying said amplitude;
wherein said amplitude is an indication of said structural integrity of said rod.

9. An apparatus for comparing the structural integrity of a rod under test to a similar rod of known structural integrity, said rod under test having a first end and a second end, said apparatus comprising:
means for generating acoustic wave energy at said first end of said rod under test;
means for measuring the amplitude of acoustic wave energy received at said first end of said rod under test reflected back from said second end of said rod under test;
means for calculating a ratio between said amplitude of said received acoustic wave energy and a predetermined value representing the structural integrity of said similar rod; and
means for displaying said ratio.

10. An apparatus for measuring the structural integrity of a rod under test comprising:
an oscillator;
a first transducer connected to said oscillator for transmitting acoustic wave energy into said rod under test;
a second transducer for receiving acoustic wave energy from said rod under test;
a high pass filter connected to said second transducer;
an amplifier connected to said high pass filter;
an envelope detector connected to said amplifier;
a display driver connected to said envelope detector, said envelope detector producing an output signal; and
a display unit connected to said display driver;
wherein said output signal is an indication of the structural integrity of said rod under test.

11. The apparatus of claim 10 further comprising a microprocessor connected to said oscillator and said second transducer; wherein said microprocessor operates to vary the oscillator frequencies, to receive output signals of said second transducer, to process said received signals together with the associated oscillator frequencies and to output the result of the processing to said display driver.

12. A method for measuring the structural integrity of a rod having a first end and a second end, said method comprising said steps of:
generating acoustic wave energy at said first end of said rod;
measuring the amplitude of acoustic wave energy received at said second end of said rod; and
displaying said amplitude;
wherein said amplitude is an indication of said structural integrity of said rod.

13. The method of claim 12 including the step of comparing said amplitude with a standard amplitude derived from a similar rod having a known structural integrity.

14. A method for comparing the structural integrity of a rod under test to a similar rod of known structural integrity, said rod under test having a first end and a second end, said method comprising the steps of:
generating acoustic wave energy at said first end of said rod under test;
measuring said amplitude of acoustic wave energy received at said second end of said rod under test;
calculating a ratio between said amplitude of said received acoustic wave energy and a predetermined value representing said structural integrity of said similar rod; and
displaying said ratio.

15. The method of claim 14, including the step of adjusting said frequency of said generated acoustic wave energy to maximize said amplitude of said received acoustic wave energy.

16. The method of claim 14 wherein the frequency of said acoustic wave energy is in the range from 100 kHz to 600 kHz.

17. The apparatus of claim 1 wherein said rod is selected from the group including bolts, bars, beams, girders and other constant cross-sectional structures.

18. The method of any one of claim 12 wherein said rod is selected from the group including bolts, bars, beams, girders and other constant cross-sectional structures.

19. A transducer interface housing for coupling acoustic energy from a transducer to a rod under test for measuring the structural integrity of the rod under test, the transducer interface housing comprising:
a first metallic block half located adjacent to a second metallic block half;
an aperture formed by said first block half and said second block half for connection to said rod under test;
hinge means for connecting said first block half and said second block half on one side;
a spring-loaded clip fastener for connecting said first block half and said second block half together on an opposite side and for urging said first and second block halves into acoustic contact with said rod under test; and
means for attaching said transducer.

20. The transducer interface housing according to claim 19, wherein said rod has a screw thread and said aperture contains a raised thread matching the screw thread of the rod.

21. The transducer interface housing according to claim 19, wherein the means for attaching said transducer comprises a recess located in either said first block half or said second block half, said recess protecting said transducer.
